(19) United States
(12) Patent Application Publication
(10) Pub. No.: US 2006/0118998 A1
(43) Pub. Date: Jun. 8, 2006

(54) PUTTER-TYPE CLUB HEAD WITH AN INSERT AND METHOD OF MANUFACTURING

(76) Inventor: Kenneth Meacham, Hemet, CA (US)

Correspondence Address: CALLAWAY GOLF C0MPANY, 2180 RUTHERFORD ROAD, CARLSBAD, CA, 92008-7328, US

(21) Appl. No.: 10/904,961

(22) Filed: Dec. 7, 2004

(51) Int. Cl. B29C 45/14

(52) U.S. Cl. 264/255

(57) ABSTRACT

A method for manufacturing an insert for a golf club head, the insert having a face plate, is disclosed herein. The method involves forming a metal face insert, co-molding a first polymer insert and then a second polymer insert. The metal face insert has a plurality of flanges that when co-molded with the first polymer insert, secure the metal face insert within the insert.

### BACKGROUND OF THE INVENTION

1. Field of the Invention

The present invention relates to a method for manufacturing an insert for a golf club head. More specifically, the present invention relates to a method of manufacturing a polymer insert with a face plate for a golf club head.

2. Description of the Related Art

Throughout the history of golf, which dates back to as early as 1457, various techniques have been used to enhance the hitting characteristics of golf club heads. Golf club heads having inserts for the striking portion have been used at least as far back as 1880's when leather face irons were manufactured in Scotland. Golfer's in the 1890's were able to purchase putters with faces composed of gutta percha. More recently, inserts composed of various materials and shapes have been put forth by the creative geniuses of the golf industry to provide golfers with better feel and control of the golf ball.

One example is an ODYSSEY® DUAL FORCE® putter having a STRONOMIC® insert that is disclosed in Magerman et al., U.S. Pat. No. 5,575,472 for a Golf Putter Head Having Face Insert And Method Of Forming The Same. The Magerman, et al. Patent discloses a putter head with a recess into which is poured or inserted a resinous material which cures and is subsequently milled to produce the putter.

Another example is an ODYSSEY® WHITE HOT® putter having an insert composed of a polyurethane material. The ODYSSEY® WHITE HOT® putter is disclosed in U.S. Pat. No. 6,238,302 for a Golf Club Head With An Insert Having Integral Tabs.

Another example is Pond, U.S. Pat. No. 5,524,331 for a Method For Manufacturing Golf Club Head With Integral Inserts that discloses a method for casting a graphite-epoxy composite insert within a recess of a face of a metal club head. The golf club head of the Pond Patent is directed at displacing the weight away from the center and increasing the moment of inertia.

Another example is Schmidt et al., U.S. Pat. No. 5,485,997, for a Golf Putter Head With Face Plate Insert Having Heightened Medial Portion, that discloses a putter head with a face plate composed of a non-metallic material such as an elastomer. The overall construction of the putter head of the Schmidt et al. Patent is directed at enlarging the sweet spot and improving the peripheral weighting.

Yet another example is found in Baker et al., U.S. Pat. No. 5,931,743 for a Putter Having Club Head With A Golf-Ball Engagement Insert And A Shaft Rearwardly Of The Insert which discloses a putter with a center shaft and an insert composed of a thermoplastic polyurethane. Another example is Jepson et al., U.S. Pat. No. 3,937,474 for a Golf Club With Polyurethane Insert, which discloses a wood having an insert on its striking face that is composed of a polyurethane formed from a tolylene diisocyanate polyether terminated prepolymer and a curing agent. The hardness of this insert varies from 40 to 75 shore D, and a Bashore Resiliometer of 17 or above. The polyurethane insert is claimed to impart additional energy to the golf ball during a golf hit.

Chen et al., U.S. Pat. No. 5,743,813 for a Golf Club Head discloses a wood composed of stainless steel with a three layer face having a first stainless steel layer, an elastic layer and a second stainless steel layer. The three-layer face does not absorb the hitting force when a golf ball is hit.

Fisher, U.S. Pat. No. 5,458,332, for a Golf Putter Head With A Cushioning Face, discloses a set of golf putters, each having an insert composed of polyurethane with a hardness in the range of 70 Shore A to about 80 Shore D. The rebound factor of each of the inserts is in the range of 12.5% to 50%, and the inserts are formulated to effect a reproducible direct linear relationship between the rebound factor and the distance of the putt.

Yet another example is McGeeney et al, European Patent Application Number 0891790 for a Multiple Density Golf Club Head And Method Of Manufacturing which discloses a putter with a central segment composed of a thermoplastic elastomer or a thermoset polymer. Possible thermoplastic elastomers include styrene co-polymers, co-polyesters, polyurethanes, polyamides, olefins and vulcanates. Possible thermoset polymers include epoxides, polyimides and polyester resins. The central segment has a minimum durometer hardness of Shore D 50. The central segment is bounded by metallic heel and to portions. However, the use of inserts is restrained in order to maintain the integrity of the game of golf.

In this regard, the Rules of Golf, established and interpreted by the United States Golf Association (“USGA”) and The Royal and Ancient Golf Club of Saint Andrews, sets forth certain requirements for a golf club head. The requirements for a golf club head are found in Rule 4 and appendix II. A complete description of the Rules of Golf are available on the USGA web page at www.usga.org. Although the Rules of Golf do not expressly state specific parameters for an insert for a putter, the Rules of Golf have been interpreted to establish that an insert for a putter should have a Shore A hardness greater than 87±2%, have a constant thickness, have a thickness of at least 0.125 inches, and not act like a spring.

Issues with the inserts of the prior art include complex processing, yellowing of polyurethane materials, and deformation under extended high temperatures.

### BRIEF SUMMARY OF THE INVENTION

The present invention provides a method for manufacturing an insert for a golf club head. The insert has a metal face with a polymer body. The method involves co-molding a first polymer insert about the metal face insert and then co-molding a second polymer insert about the combined first polymer insert and metal face insert. A plurality of flanges of the metal face insert secure the metal face insert within the polymer body.

Having briefly described the present invention, the above and further objects, features and advantages thereof will be recognized by those skilled in the pertinent art from the following detailed description of the invention when taken in conjunction with the accompanying drawings.

### BRIEF DESCRIPTION OF THE SEVERAL VIEWS OF THE DRAWINGS

FIG. 1 is a perspective view of one embodiment of a golf club head without an insert in the recess of the club head body.

FIG. 1A is a front view of the club head of FIG. 1 with the insert placed therein.

FIG. 1B is a side view of the club head of FIG. 1.

FIG. 1C is a rear view of the club head of FIG. 1.

FIG. 1D is a top view of the club head of FIG. 1.

FIG. 2 is a front view of another embodiment of a golf club head with an insert in the recess of the club head body.

FIG. 2A is a partial cross-sectional side view of the club head of FIG. 2.

FIG. 2B is a rear view of the club head of FIG. 2.

FIG. 2C is a top view of the club head of FIG. 2.

FIG. 2D is an enlarged view of circle D of FIG. 2A.

FIG. 3 is a front view of another embodiment of a golf club head with an insert in the recess of the club head body.

FIG. 3A is a side view of the club head of FIG. 3.

FIG. 3B is a rear view of the club head of FIG. 3.

FIG. 3C is a top view of the club head of FIG. 3.

FIG. 4 is a front view of another embodiment of the golf club head of the present invention with an insert in the recess of the club head body.

FIG. 4A is a side view of the club head of FIG. 4.

FIG. 4B is a rear view of the club head of FIG. 4.

FIG. 4C is a top view of the club head of FIG. 4.

FIG. 5 is a top perspective another embodiment of a golf club head with an insert in the recess of the club head body.

FIG. 6 is a front view of the golf club head of FIG. 5.

FIG. 7 is a side view of the golf club head of FIG. 5.

FIG. 8 is a top view of the golf club head of FIG. 5.

FIG. 9 is a bottom view of the golf club head of FIG. 5.

FIG. 10 is a flow chart of a general method of the present invention.

FIG. 11 is a flow chart of a specific method of the present invention.

FIG. 12 is a top plan view of a stamped metal face insert.

FIG. 12 A is an end view of the insert of FIG. 12.

FIG. 13 is a top plan view of a machined metal face insert.

FIG. 13A is an end view of the machined metal face insert of FIG. 13.

FIG. 13 B is a front side view of the machined metal face insert of FIG. 13.

FIG. 14 is a front plan view of a first polymer insert co-molded about a machined metal face insert.

FIG. 14A is a front side view of the FIG. 14.

FIG. 15 is a front plan view of a second polymer insert co-molded about the first polymer insert and a machined metal face insert.

FIG. 15A is a front side view of the FIG. 14.

### DETAILED DESCRIPTION OF THE INVENTION

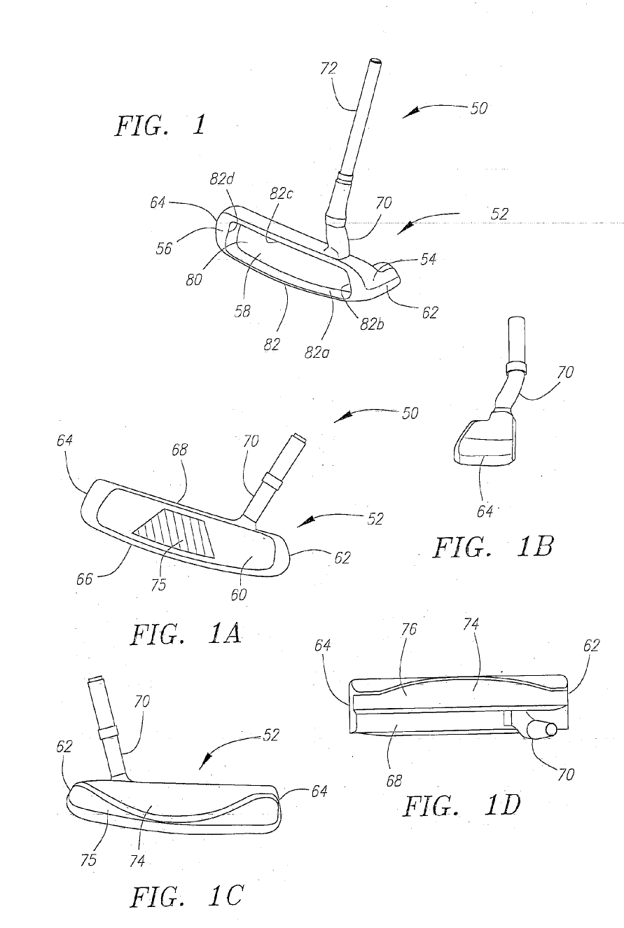

As shown in FIGS. 1 through 1D, a putter is generally designated 50. The putter 50 includes a club head 52 having a body 54 with a front face 56 with a recess 58 therein. The club head 52 also includes an insert 60 disposed within the recess 56. The insert 60 extends along most of the face 56 from a heel 62 of the club head 52 to a toe 64 of the club head 52, and from a sole 66 of the club head 52 to a crown 68 of the club head 52. A face plate 75 is co-molded with insert as discussed below. The club head 52 also has a hosel 70 for connection to a shaft 72. Opposite of the front face 56 of the club head 52 is a rear 74 of the club head 52.

The body 54 of the club head 52 is preferably composed of a metallic material such as stainless steel. Other metallic materials include titanium, aluminum, tungsten, zinc, magnesium, and alloys of stainless steel and tungsten. However, those skilled in the pertinent art will recognize that the body 54 may be composed of other materials without departing from the scope and spirit of the present invention. Further, the non-insert portion of the face 56 may be smooth or textured to provide a consistent or non-consistent surface with the exterior surface of the insert. Additionally, the body 54 may be specifically weighted to provide a specific center of gravity and inertial properties for the putter 50.

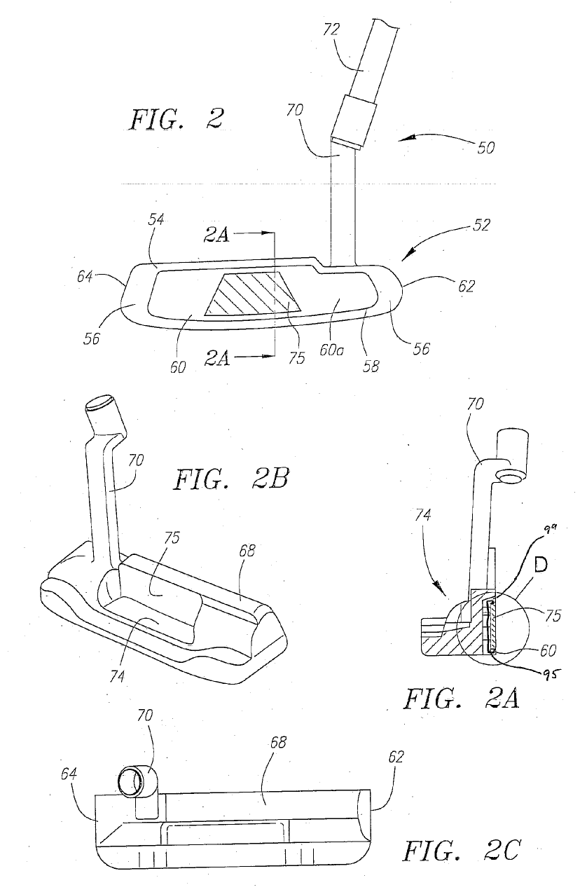

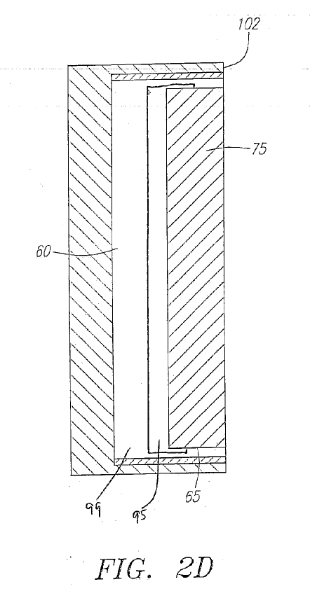

FIGS. 2-4C illustrate various embodiments of putters 50. Each of the putters 50 of FIGS. 2-4C has a club head 52 with a body 54, an insert 60 disposed within a recess 58 of the body 54, and a face plate 75. The putters 50 illustrated in FIGS. 1-4C are flanged blade, mallet and semi-mallet putters, however, those skilled in the art will recognize that other similar putter designs may be utilized without departing from the scope and spirit of the present invention. In a preferred embodiment, each of the club heads 52 weigh approximately 328 grams±7 grams. Further, in a preferred embodiment, the recess 58 of each of the club heads 52 has a depth of approximately 0.205 inches±0.010 inches.

Referring specifically to FIG. 1, the recess 58 of the body 54 is defined by a recess face wall 80 which is substantially parallel with the insert 60, and a recess edge wall 82 which is substantially perpendicular to the recess face wall 80. The recess face wall 80 defines the depth of the recess 58 that will determine the thickness of the polymer insert 60. The recess edge wall 82, as shown in FIG. 1, is composed of a bottom recess edge wall 82a, a heel recess edge wall 82b, a top recess edge wall 82c and a toe recess edge wall 82d. The recess edge wall 82 defines the shape of the recess 58, and the length of the recess edge wall 82 is determined by the depth of the recess 58. In a preferred embodiment, the insert 60 will engage the recess edge wall 82 as described below.

The putter 50 of FIGS. 1-1D is a flanged blade style putter. The rear 74 of the club head 52 has a rear wall 75 and a flanged portion 77. The insert 60 of this embodiment occupies approximately 67.90% of the face area of the club head 52. The insert 60 also occupies approximately 20.71% of the volume of the club head 52. Yet further, the insert 60 of this embodiment is approximately 3.95% of the weight of the club head 52.

The putter 50 of FIGS. 2-2C is also a blade style putter, however, it has an offset hosel 70, and an insert 60 with a panhandle portion 60a. The insert 60 is one-piece, including the panhandle portion 60a. It is apparent from FIG. 2 that this putter 50 has a larger area of the non-insert portion of the face 56 than the embodiment shown in FIG. 1A. The insert 60 of this embodiment occupies approximately 69.22% of the face area of the club head 52. The insert 60 also occupies approximately 20.33% of the volume of the club head 52. Yet further, the insert 60 of this embodiment is approximately 3.86% of the weight of the club head 52. FIG. 2D illustrates a enlarged view of a cross-section of the putter 50.

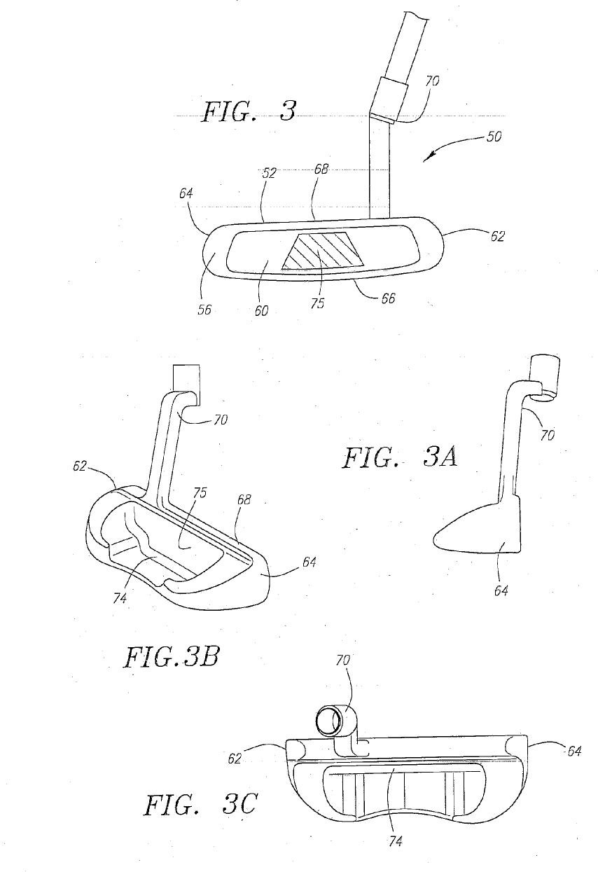

The putter 50 of FIGS. 3-3C is a half-mallet style putter with an offset hosel 70. The insert 60 has a trapezoidal shape with parallel sides and a curved bottom portion. It is apparent from FIG. 3 that the toe end and heel end of the face 56 of this putter 50 has a large area of the non-insert portion. The insert 60 of this embodiment occupies approximately 68.27% of the face area of the club head 52. The insert 60 also occupies approximately 17.15% of the volume of the club head 52. Yet further, the insert 60 of this embodiment is approximately 3.08% of the weight of the club head 52.

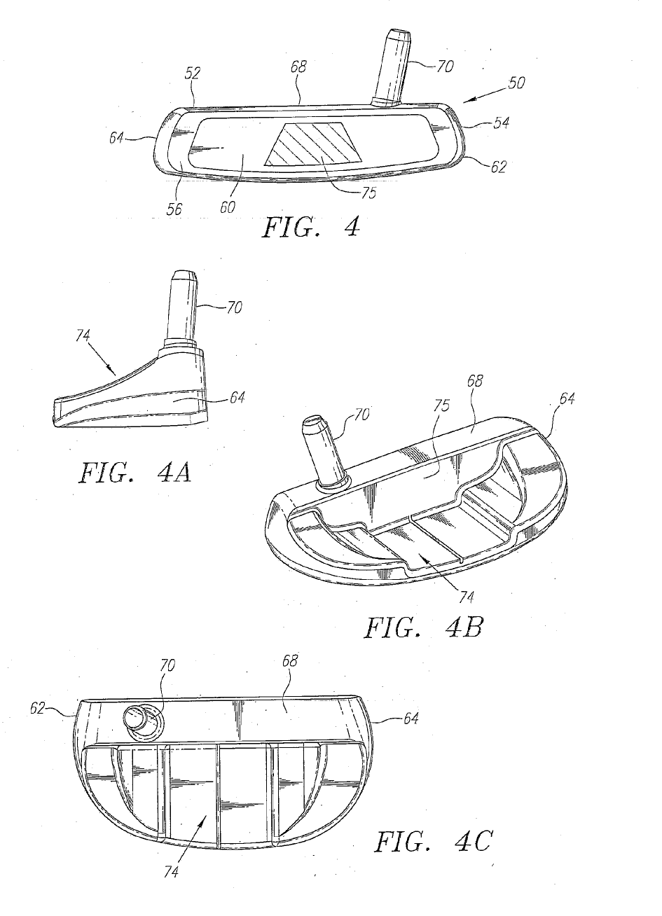

The putter of FIGS. 4-4C is a mallet style putter, however, it does not have an offset hosel 70. The insert 60 of this embodiment occupies the largest amount of the face area of the club head 52, approximately 70.38%. However, the insert 60 occupies the smallest volume of the club head 52, approximately 16.24%. Yet further, the insert 60 of this embodiment is the lightest, weighing approximately 2.46% of the club head 52.

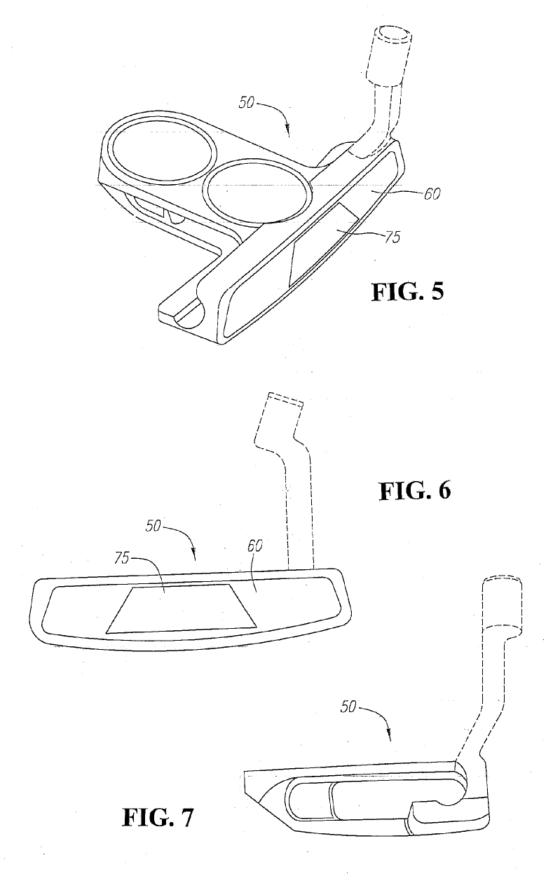

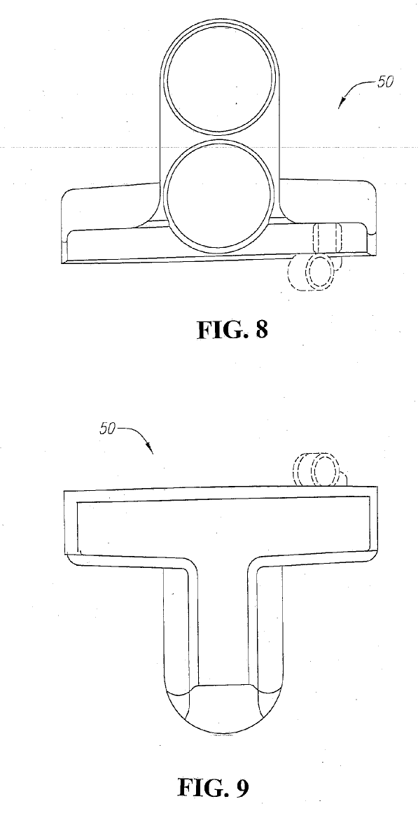

FIGS. 5-9 illustrate an extended mallet type putter-type golf club head 20 with an alignment system such as disclosed in U.S. Pat. No. 6,471,600, issued on Oct. 22, 2002, which relevant parts are hereby incorporated by reference.

In a preferred embodiment, the insert 60 is composed of a thermoplastic polyurethane material, preferably an injection moldable thermoplastic polyurethane. A preferred thermoplastic polyurethane is available from Bayer under the tradename Desmopan KU2-88956.

The Shore D hardness of the thermoplastic polyurethane material for the insert 60 preferably ranges from 40 to 70 Shore D, more preferably from 50 to 65 Shore D, and is most preferably approximately 60 Shore D.

The thickness of the insert 60 may vary depending on its application. A preferred thickness for a putter 50 is in the range of 0.125 to 0.500 inch. A preferred range of thickness is 0.188 inch to 0.200 inch. A preferred thickness is 0.198 inch. The thickness of the insert 60 is increased or decreased to influence the feel to the golfer during impact with a golf ball.

The face plate 75 is preferably composed of a metal material. Such metal materials include stainless steel, steel, other steel alloys, titanium, titanium alloys, amorphous metals, aluminum, aluminum alloys, magnesium, magnesium alloys, bronze, and other like metal materials. The face plate 75 preferably has a thickness ranging from 0.020 inch to 0.075 inch, and more preferably ranging from 0.035 inch to 0.045 inch, and most preferably having a thickness of 0.040 inch. The face plate 75 preferably has a height, Hf, that ranges from 0.30 inch to 0.80 inch, more preferably from 0.50 inch to 0.70 inch, and most preferably 0.60 inch. The face plate 75 preferably has a trapezoidal shape with a bottom width, Wf, ranging from 1.0 inch to 2.0 inches, more preferably from 1.20 inches to 1.75 inches, and most preferably 1.27 inches. The top width, W′f, of the face plate 75 preferably has a length ranging from 0.50 inch to 1.5 inches, more preferably from 0.70 inch to 1.25 inches, and most preferably 0.88 inch.

The face plate 75 preferably is positioned at the center of the face of the putter 20. The face plate 75 preferably covers less than 90% of the exterior surface of the insert 60, and more preferably less than 60% of the exterior surface of the insert, and most preferably covers between 25% to 50% of the exterior surface of the insert 60.

The insert 60 has a plurality of tabs spaced substantially equidistant apart. In a preferred embodiment, the distance “d” is 0.41 inches. However, those skilled in the pertinent art will recognize that the value of d may be adjusted for various embodiments. The plurality of tabs lie on a perimeter of the insert 60. The perimeter defines the thickness of the insert 60. A most preferred thickness is 0.198 inches, however the thickness may preferably range from 0.125 to 0.50 inches. The insert 60 has an interior surface and an exterior surface. The interior surface faces the recess face wall 80 while the exterior surface forms a portion of the face 56 of the club head 52.

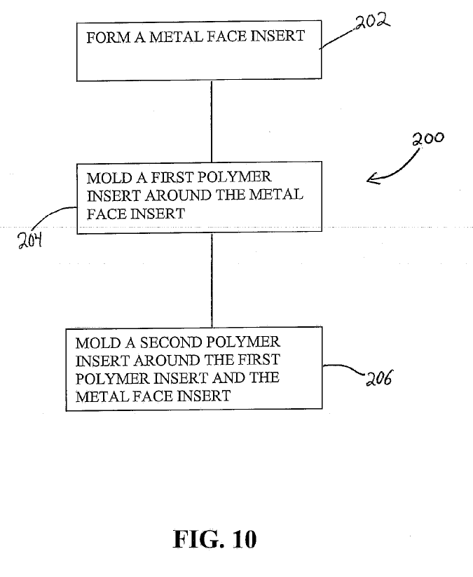

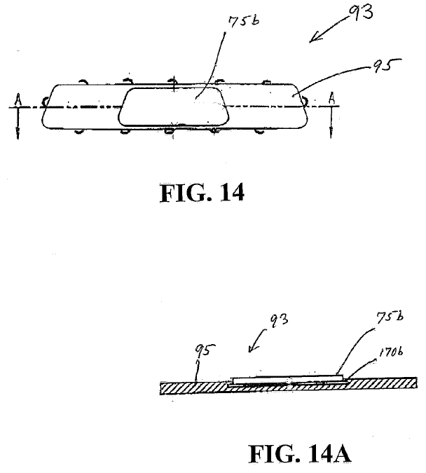

The face plate 75 is preferably co-molded with a first insert and second insert portion to form the final insert 60. As illustrated in FIG. 10, a general method for co-molding the insert 60 is designated 200. At block 202, a metal face insert 75a is formed from a sheet of metal and machined to become a machine face insert 75b as shown in FIG. 13-13B. The metal face insert 75b is generally formed into a trapezoidal shape. At block 204, a first polymer insert 95 is co-molded about the metal face insert 75b, as shown in FIGS. 14 and 14A. At block 206, the second polymer insert 99 is co-molded about the first polymer insert body 95 and the metal face insert 75b to form the final insert 60.

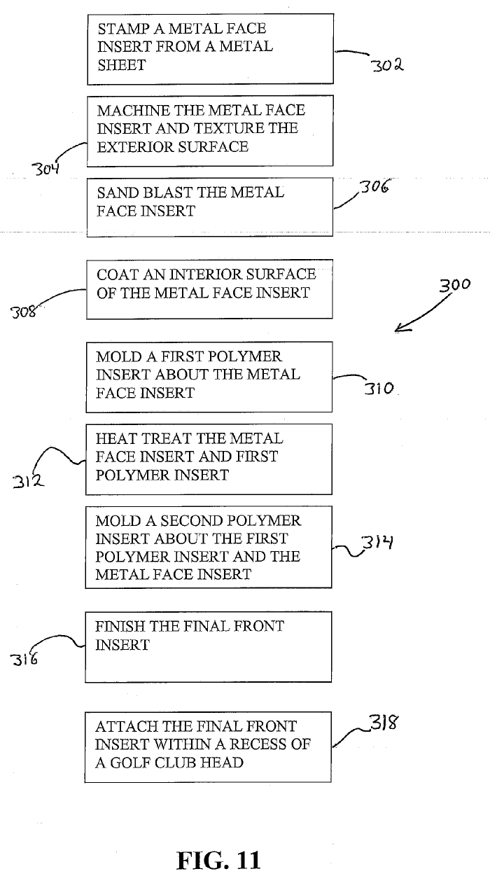

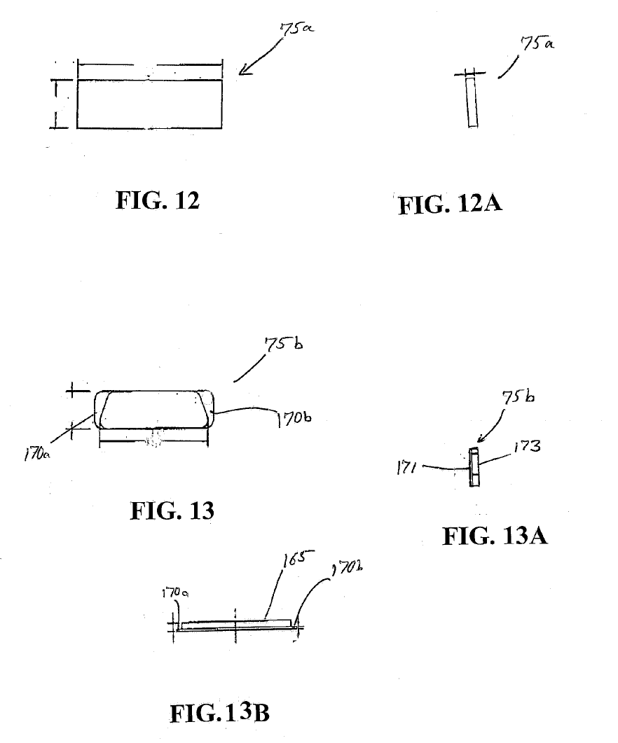

A more specific method 300 is illustrated in FIG. 11. At block 302, a metal face insert 75a is stamped from a sheet of metal, preferably stainless steel. The metal face insert 75a is as shown in FIGS. 12 and 12A. The metal face insert 75a preferably has a thickness of approximately 3.2 millimeters, a length of approximately 55 millimeters and a height of approximately 18 millimeters.

At block 304, the metal face insert 75a is machined and an exterior surface 173 is textured to form the machined metal face insert 75b. As shown in FIGS. 13, 13A and 13B, a toe flange 170a and a heel flange 170b are formed during the machining of the metal face insert 75a. A body 165 of the machined metal face insert 75b extends above the toe flange 170a and the heel flange 170b. The machined metal face insert 75b preferably has a thickness of approximately 3.2 millimeters, a length of approximately 41 millimeters and a height of approximately 14 millimeters. Each of the toe flange 170a and the heel flange 170b has a thickness of approximately 0.8 millimeters. The toe flange 170a and the heel flange 170b provide a locking mechanism for securing the face insert 75 within the polymer insert 60.

At block 306, the metal face insert is sand blasted for providing better adhesion of the metal the polymer. At block 308, an interior surface 171 of the machined metal face insert 75b is coated with an adhesive material, preferably CHEMLOCK 213.

At block 310, a first polymer insert body 95 is co-molded about the machined metal face insert 75b to form a combined metal face insert/first polymer insert body 93. The first polymer insert body 95 is preferably composed of a thermoplastic polyurethane such as Bayer DESMOPAN KU2-88956. As shown in FIGS. 14 and 14A, the first polymer insert body 95 is co-molded around the interior surface 173 of the machined metal face insert 75b and around the toe flange 170a and the heel flange 170b thereby securing the machined metal face insert 75b within the first polymer insert body 95. The body 165 of the machined metal face insert 75b extends above a front surface of the first polymer insert body 95.

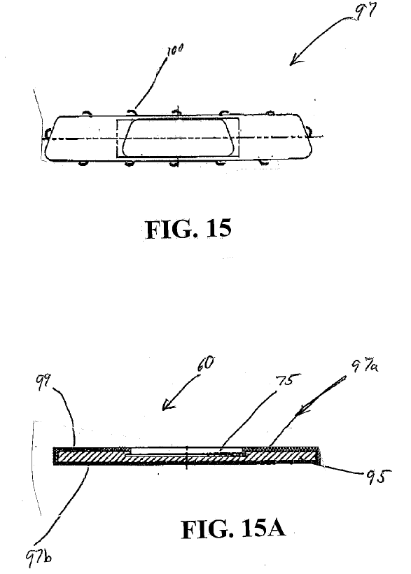

At block 312, the combined metal face insert/first polymer insert body 93 is heat treated, preferably by baking the combined metal face insert/first polymer insert body 93 in an oven at an oven temperature ranging from 100 to 150 degrees Celsius, and most preferably 120 degrees Celsius, for a time period ranging from one to two hours, most preferably one and a half hours. At block 314, the second polymer insert body 99 is co-molded about the combined metal face insert/first polymer insert body 93 to form the final insert 60. As shown in FIGS. 15 and 15A, the second polymer insert body 99 is preferably co-molded about the first polymer insert body 95. An exterior surface of the second polymer insert body 99 is preferably flush with the exterior surface 173 of the machined metal face insert 75b. The second polymer insert body 99 preferably is co-molded against the side walls of the body 165 of the machined metal face insert 75b. The co-molding preferably includes forming a plurality of tabs 100 on the perimeter of the insert 60.

At block 316, the final front insert 60 is finished, preferably by painting or coating the exterior surface with a durable top coat. At block 318, the insert 60 is attached within the recess of the golf club head.

From the foregoing it is believed that those skilled in the pertinent art will recognize the meritorious advancement of this invention and will readily understand that while the present invention has been described in association with a preferred embodiment thereof, and other embodiments illustrated in the accompanying drawings, numerous changes, modifications and substitutions of equivalents may be made therein without departing from the spirit and scope of this invention which is intended to be unlimited by the foregoing except as may appear in the following appended claims. Therefore, the embodiments of the invention in which an exclusive property or privilege is claimed are defined in the following appended claims.

What is claimed is:

1. A method for manufacturing a front insert for a putter-type club head, the method comprising:
forming a metal face insert;
placing an adhesive on an interior surface of the metal face insert;
co-molding a first polymer insert about the metal face insert, the first polymer insert covering the interior surface of the metal face insert, an exterior surface of the metal face insert extending beyond a front surface of the first polymer insert; and
co-molding a second polymer insert about the first polymer insert and the metal face insert to form a final front insert, an exterior surface of the metal face insert flush with an exterior surface of the second polymer insert.

2. The method according to claim 1 wherein the metal face insert is composed of a stainless steel material.

3. The method according to claim 1 wherein the first polymer insert and the second polymer insert are composed of a thermoplastic polyurethane.

4. The method according to claim 1 wherein forming a metal face insert comprises stamping a metal face insert from a sheet of metal and machining the metal face insert.

5. The method according to claim 4 wherein machining the metal face insert comprises forming a plurality of flanges in the metal face insert.

6. The method according to claim 1 wherein the final front insert has a thickness ranging from 0.125 inch to 0.500 inch.

7. The method according to claim 5 wherein the first polymer insert is co-molded around each of the plurality of flanges of the metal face insert.

8. The method according to claim 1 wherein the metal face insert has a trapezoidal shape.

9. The method according to claim 1 wherein the metal face insert is composed of a titanium alloy material.

10. A method for manufacturing a front insert for a putter-type club head, the method comprising:
stamping a metal face insert from a sheet of stainless steel;
machining the metal face insert to create a machined metal face insert with a main body, a heel flange and a toe flange, the main body having an exterior surface with a texture;
sand blasting an interior surface of the machined metal face insert;
coating an adhesive on the interior surface of the machined metal face insert;
injection molding a first polymer insert about the machined metal face insert to create a first co-molded dual insert, the first polymer insert covering the adhesive coated interior surface of the machined metal face insert, the first polymer insert covering the heel flange and the toe flange of the machined metal face insert, the exterior surface of the machined metal face insert extending beyond a front surface of the first polymer insert;
baking the first co-molded dual insert in an oven for a time period ranging from 1 hour to 2 hours, the temperature of the oven ranging from 100 to 150 degrees Celsius; and
injection molding a second polymer insert about the first co-molded dual insert to create a final co-molded dual insert, an exterior surface of the machined metal face insert flush with an exterior surface of the second polymer insert.
